(19) United States
(12) Patent Application Publication
(10) Pub. No.: US 2005/0225788 A1
(43) Pub. Date: Oct. 13, 2005

(54) Exposure apparatus and exposure method

(75) Inventors: Toru Katayama, Kanagawa (JP); Daisuke Nakaya, Kanagawa (JP); Naozumi Jogo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/090,070

(22) Filed: Mar. 28, 2005

(30) Foreign Application Priority Data
Mar. 29, 2004 (JP) 2004-096564

(51) Int. Cl. G06K 1/00

(52) U.S. Cl. 358/1.12

(57) ABSTRACT

An exposure apparatus, in which a light beam from a recording head is irradiated on a recording medium mounted on a recording stage, and the recording stage and the recording head are relatively moved, thereby allowing a predetermined image to be exposed on the recording medium, including a displacement detecting section that detects displacement caused by pitching vibration occurring accompanied by movement of the recording stage; a storage section that stores therein displacement-amount data detected by said displacement detecting section; a correction section that corrects, based on the displacement-amount data stored in said storage section, a timing at which the light beam is irradiated from the recording head; and a control section that controls, based on the timing corrected by said correction section, exposure for the recording medium, is provided to correct the displacement and reduce distortion of an image to be formed on the recording medium.

### CROSS-REFERENCE TO RELATED APPLICATION

This application claims priority under 35 USC 119 from Japanese Patent Application No. 2004-096564, the disclosure of which is incorporated by reference herein.

### BACKGROUND OF THE INVENTION

1. Field of the Invention

The present invention relates to an exposure apparatus and an exposure method in which distortion of an image is corrected, which distortion is caused by pitching vibration that occurs due to movement of a recording stage in exposure processing.

2. Description of the Related Art

Conventionally, as an apparatus in which a predetermined pattern is recorded on a substrate of a recording medium, for example, a printed wiring board (hereinafter referred to as “PWB”) or a flat panel display (hereinafter referred to as “FPD”), a surface exposure apparatus using a mask has been widely used.

However, the fineness of a pattern to be recorded on PWB or FPD (a wiring pattern) becomes higher accompanied by high packaging density of parts, and a problem about displacement of a recording position caused along with expansion and contraction of a mask has become apparent. For example, when a multi-layer printed wiring board is used, alignment of a hole such as a through hole formed on a substrate, and a pattern on each of the layers cannot be carried out with a high degree of accuracy. Accordingly, a problem arises that the fineness of a pattern cannot be made higher.

As a technique provided to solve these problems, there has been known a laser-scanning exposure apparatus in which a pattern is recorded directly on a recording medium, without using a mask, by irradiating a light beam from a recording head. In this laser-scanning exposure apparatus, a pattern can be drawn on a recording medium by carrying out exposure in which light beams are irradiated from multiple recording heads, which are linearly arranged, at a predetermined timing while moving a recording stage with a recording medium placed thereon.

However, in the aforementioned laser-scanning exposure apparatus, when the recording stage with a recording medium placed thereon is moved for drawing of a pattern, this movement causes pitching vibration on the recording stage and displacement occurs on the recording stage, thereby causing distortion in the pattern drawn on the recording medium. The pitching vibration mentioned herein means a pendulum's oscillation that draws an arc in a direction perpendicular to the recording stage. This would slope the surface of the recording stage, and therefore, the optical length of a light beam irradiated from an upper side of the recording stage varies, and the amount of variation forms displacement of a scanning pitch on the surface of the recording stage. The pitching vibration occurs depending on the production precision of the exposure apparatus, and accompanied by movement of the recording stage, high reproducibility is obtained. This makes it possible to previously prepare data about displacement of the recording stage.

Accordingly, Japanese Patent Application Laid-Open (JP-A) No. 2000-321025 discloses a laser-scanning exposure apparatus in which displacement-amount data is prepared in advance by recording behavior of the recording stage due to moving using two cameras provided at both sides of the recording stage, and at the time of drawing a pattern on a recording medium, the behavior of the recording stage due to moving is corrected based on the previously prepared displacement-amount data, a light beam is irradiated on the recording medium, thereby allowing a pattern to be drawn thereon.

However, when the recording stage is moved, pitching vibrations, which vary delicately with different positions, occur on the recording stage due to yawing movement (i.e., the behavior of the recording stage in a direction in which the recording stage is moved). To this end, the proper timing at which a light beam is irradiated by a recording head when a pattern is drawn on the recording medium, is slightly different from others with respective positions of recording heads. Accordingly, in order to achieve pattern drawing more precisely, it is necessary to carry out correction by recording the behavior of the recording stage at a greater number of positions and obtaining an amount of displacement at the position of each recording head. However, if the number of cameras used for recording the behavior increases, the manufacturing cost increases.

### SUMMARY OF THE INVENTION

In view of the aforementioned circumstances, the present invention provides an exposure apparatus and an exposure method, which can correct, for each of positions of recording heads, displacement caused by pitching vibration occurring due to movement of a recording stage and also can reduce distortion of an image to be drawn on the recording medium.

The first aspect of the present invention is an exposure apparatus in which a light beam from a recording head is irradiated on a recording medium mounted on a recording stage, and the recording stage and the recording head are relatively moved, thereby allowing a predetermined image to be exposed on the recording medium, the apparatus comprising: a displacement detecting section that detects displacement caused by pitching vibration occurring accompanied by movement of the recording stage; a storage section that stores therein displacement-amount data detected by the displacement detecting section; a correction section that corrects, based on the displacement-amount data stored in the storage section, a timing at which the light beam is irradiated from the recording head; and a control section that controls, based on the timing corrected by the correction section, exposure for the recording medium.

According to the first aspect of the invention, when the recording medium is mounted on the recording stage and the recording stage moves relatively to the recording head, a light beam is irradiated from the recording head to the recording medium, and a predetermined image is formed by exposure on the recording medium.

At this time, pitching vibration occurs on the recording stage accompanied by movement thereof. Therefore, the displacement detecting section detects displacement of the recording stage caused by the vibration and stores displacement-amount data in the storage section. In the timing correction section, a timing at which the light beam is irradiated from the recording head is corrected based on the displacement-amount data stored in the storage section, and a position at which the light beam is exposed is changed. In the exposure control section, exposure for the recording medium is controlled based on the corrected timing, and displacement of the recording stage caused by pitching vibration is corrected, and distortion of an image to be drawn is corrected.

In this manner, distortion of an image to be drawn can be corrected, and therefore, an image to be drawn on the recording medium can be represented finely.

The second aspect of the present invention is an exposure apparatus in which light beams from plural recording heads arranged linearly are irradiated on a recording medium mounted on a recording stage, and the recording stage is relatively moved in a direction intersecting a direction in which the recording heads are arranged linearly, thereby allowing a predetermined image to be exposed on the recording medium, the apparatus comprising: a displacement detecting section that detects displacement caused by pitching vibration that occurs accompanied by movement of the recording stage; a storage section that stores therein displacement-amount data detected by the displacement detecting section; a correction section that corrects, based on the displacement-amount data stored in the storage section, a timing at which the light beam is irradiated for each of the recording heads; and a control section that controls, based on the timing corrected by the correction section, exposure for the recording medium.

According to the second aspect of the invention, recording heads are arranged linearly in plural rows, and exposure by the plural recording heads is carried out in such a manner that the recording stage moves relatively to the recording heads in a direction intersecting a direction in which the recording heads are arranged linearly. Due to this movement of the recording stage, pitching vibration occurs on the recording stage and displacement in the direction in which the recording stage moves occurs. Accordingly, the displacement detecting section detects displacement caused by pitching vibration and stores displacement-amount data in the storage section. The correction section corrects, based on the displacement-amount data stored in the storage section, a timing at which a light beam is irradiated from each of the recording heads, and changes a position at which the light beam is exposed by each of the recording heads. As a result, in the image formed by exposure with the control section, displacement caused by pitching vibration is corrected for each of the positions of the recording heads, and distortion of an image to be drawn on the recording medium can be reduced.

In this manner, distortion of an image to be drawn can be corrected, and therefore, the image to be drawn on the recording medium can be represented finely.

The third aspect of the present invention is the exposure apparatus according to the first or second aspect of the invention, wherein one row (or plural rows) of markings are provided on the recording stage so as to be arranged at fixed intervals along a direction in which the recording stage and the recording head are relatively moved, and wherein the displacement detecting section comprises: at least one image pickup section that picks up the markings on the one row (or on each of the plural rows) on the recording stage at each predetermined timing; a first moving section that moves the image pickup section in a direction intersecting the direction of relative movement, thereby allowing the markings on the one row (or on each of the plural rows) to be picked up; and a first detecting section that detects, based on the position of the marking within an image picked up by the image pickup section, the displacement caused by pitching vibration of the recording stage.

According to the third aspect of the invention, one row or plural rows of markings are arranged on the recording stage at fixed intervals along a direction in which the recording head and the recording stage moves relatively to each other. The image pickup section picks up the markings on the moving recording stage at each predetermined timing, and therefore, the first detecting section can detect displacement of the recording stage from the position of each of the marking within the pick up image. Further, the first moving section can move the image pickup section in a direction intersecting a direction of the relative movement (the direction along the row(s) of the markings). As a result, the markings on the row or the respective rows can be picked up by one image pickup section, and an increase in the manufacturing cost of the exposure apparatus can be restrained.

The fourth aspect of the present invention is the exposure apparatus wherein the displacement detecting section comprises: a laser length-measuring machine that is disposed in a direction in which the exposure head moves relatively to the recording stage, and measures a distance to the recording stage at each predetermined timing; a second moving section that moves the laser length-measuring machine in a direction intersecting the direction of the relative movement within a range in which the distance to the recording stage can be measured; and a second detecting section that detects the displacement caused by pitching vibration of the recording stage, based on a changed amount of the distance to the recording stage, measured by the laser length-measuring machine at each predetermined timing.

According to the fourth aspect of the invention, the laser length-measuring machine is disposed in a direction in which the recording head and the recording stage move relatively to each other, and can measure a distance to the moving recording stage, at each predetermined timing. At this time, if displacement caused by pitching vibration does not occur on the recording stage, a distance to the recording stage measured by the laser length-measuring machine at each predetermined timing varies with a fixed interval. Accordingly, the second detecting section can detect displacement of the recording stage from changed-amount of the distance to the recording stage, measured by the laser length-measuring machine at each predetermined timing. (For example, the changed-amount is a difference between distance to the recording stage measured previously and distance to the recording stage measured at this time) Further, the second moving section can move the laser length-measuring machine with respect to the recording stage in a direction intersecting a direction of the relative movement, and therefore, can detect displacement at plural positions. Moreover, due to the use of the laser length-measuring machine, it is also unnecessary to provide markings on the recording stage.

The fifth aspect of the present invention is the exposure apparatus wherein the displacement detecting section comprises: a position pattern exposure section that forms a predetermined position-data-acquiring pattern on the recording medium by exposing the recording medium; and a registration section that registers, in the storage section, the displacement-amount data obtained from the position-data-acquiring pattern formed on the recording medium by exposing by the position pattern exposure section.

According to the fifth aspect of the invention, the position pattern exposure section carries out exposure for a predetermined position-data-acquiring pattern, and therefore, can obtain displacement-amount data from an amount of displacement obtained by measuring an interval of the exposed pattern (for examples, markings), or the like. The registration section can register the obtained displacement-amount data in the storage section. Therefore, at the time of exposure, displacement caused by pitching vibration is corrected based on the displacement-amount data registered in the storage section, and distortion of an image to be drawn on the recording medium can be reduced.

The sixth aspect of the present invention is the exposure apparatus wherein the markings are provided on the recording stage by mounting a marking chart on which the markings are formed on the recording stage.

According to the sixth aspect of the invention, the markings can be provided on the recording stage by mounting a marking chart on which the markings are formed on the recording stage. Therefore, the position of the markings can be appropriately altered. Further, when no marking is required, the marking chart can be removed.

The seventh aspect of the present invention is the exposure apparatus wherein the displacement detecting section detects the displacement at each of positions corresponding to all the recording heads.

According to the seventh aspect of the invention, the displacement detecting section can detect displacement at plural positions. Therefore, by detecting displacement-amount data at positions corresponding to all the recording heads, correction of the respective recording heads can be carried out optimally by the correction section.

The eighth aspect of the present invention is the exposure apparatus wherein the laser length-measuring machine is provided so as to measure a distance to a length measuring portion provided on the recording stage at each predetermined timing.

The ninth aspect of the present invention is an exposure apparatus wherein the position pattern exposure section includes a pattern input section for inputting the position-data-acquiring pattern.

The tenth aspect of the present invention is an exposure method in which a light beam from a recording head is irradiated on a recording medium mounted on a recording stage, and the recording stage and the recording head are relatively moved, thereby allowing a predetermined image to be exposed on the recording medium, the method comprising the steps of: detecting an amount of displacement caused by pitching vibration occurring accompanied by movement of the recording stage; storing data of the amount of displacement; correcting, based on the stored amount of displacement, a timing at which the light beam is irradiated from the recording head; and controlling exposure for the recording medium based on the corrected timing.

The eleventh aspect of the present invention is an exposure method in which light beams from plural recording heads arranged linearly are irradiated on a recording medium mounted on a recording stage, and the recording stage is relatively moved in a direction intersecting a direction in which the recording heads are arranged linearly, thereby allowing a predetermined image to be exposed on the recording medium, the method comprising the steps of: detecting displacement caused by pitching vibration that occurs accompanied by movement of the recording stage; storing data of the detected amount of displacement; correcting, based on the stored displacement-amount data, a timing at which the light beam is irradiated for each of the recording heads; and controlling exposure for the recording medium based on the corrected timing.

### BRIEF DESCRIPTION OF THE DRAWINGS

FIG. 1A is a perspective view schematically showing an exposure apparatus according to a first embodiment of the present invention and FIG. 1B is an enlarged view.

FIG. 2 is a side view schematically showing the exposure apparatus according to the first embodiment.

FIG. 3A is a plan view showing a region exposed by an exposure head unit; and FIG. 3B is a plan view showing an arrangement pattern of a head assembly.

FIG. 4 is a plan view showing a state in which a dot pattern is arranged in a single head assembly.

FIG. 5 is a diagram showing a marking image picked up by a CCD camera 34 according to the first embodiment.

FIGS. 6A to 6D are diagrams each showing a pattern of markings 24.

FIG. 7 is a functional block diagram for control in detecting displacement caused by pitching vibration, and carrying out exposure, in accordance with the first embodiment.

FIG. 8 is a graph showing an amount of displacement caused by pitching vibration occurring in an exposure stage 16 according to the first embodiment.

FIG. 9 is a table showing pulse correction numbers.

FIGS. 10A and 10B are wave form charts each showing a reset timing.

FIGS. 11A and 11B are flow charts showing processing for detecting an amount of displacement according to the first embodiment and processing for preparing correction number data, respectively.

FIG. 12 is a diagram showing detection of an amount of displacement caused by pitching vibration of an exposure stage using a laser length measuring machine.

FIG. 13 is a functional block diagram for controlling in detecting displacement caused by pitching vibration, and carrying out exposure, in accordance with a second embodiment of the present invention.

FIG. 14 is a flow chart for exposure of a pattern image for acquiring position data, and for acquisition of pulse correction numbers, according to the second embodiment of the present invention.

### DETAILED DESCRIPTION OF THE INVENTION

### First Embodiment

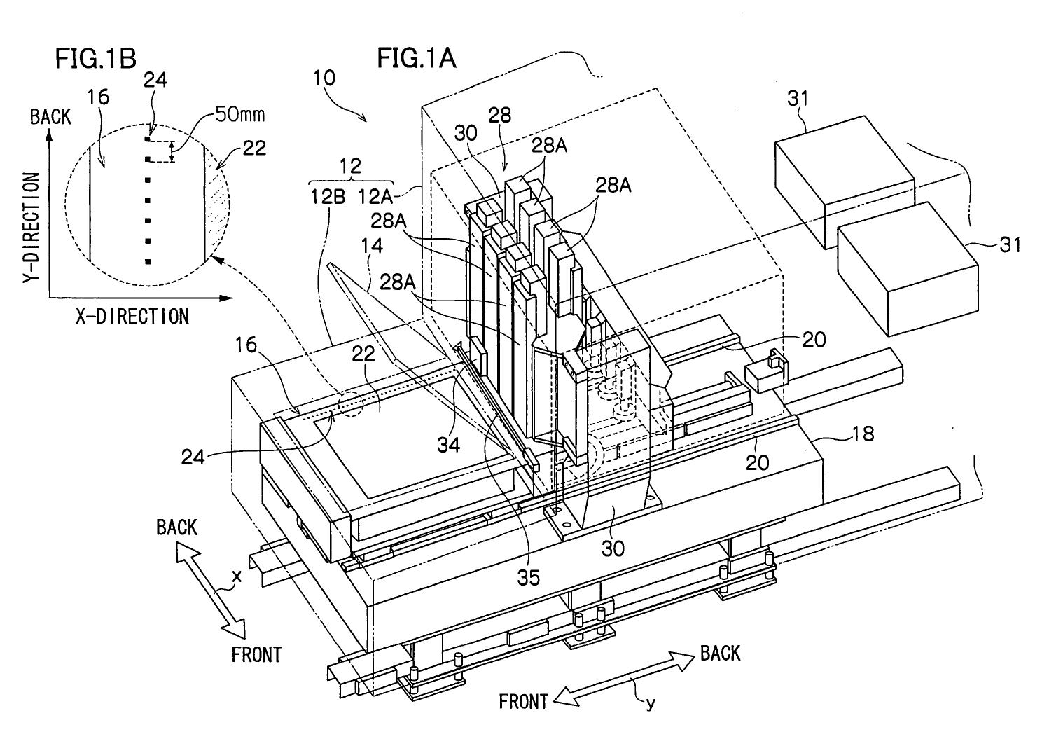

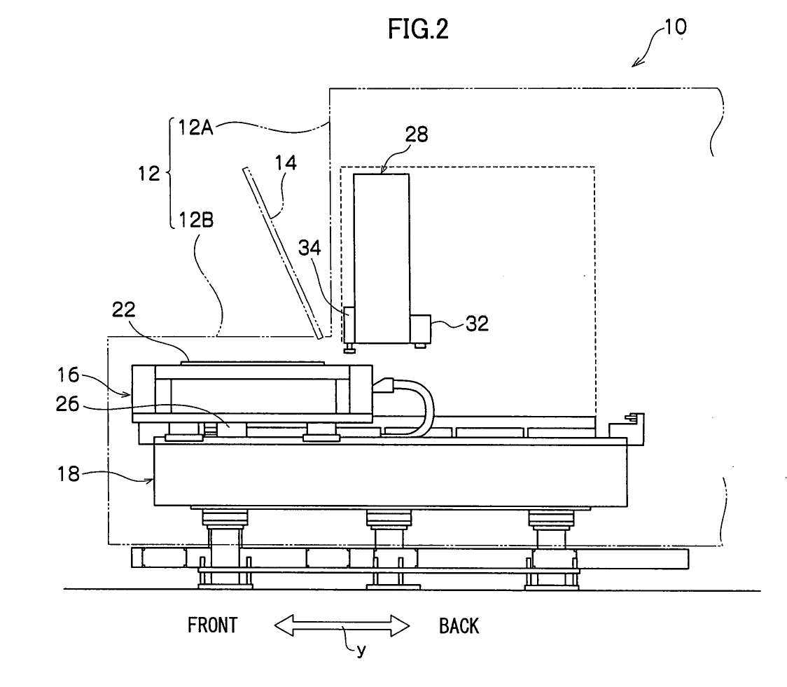

FIG. 1A and FIG. 2 show a flatbed type exposure apparatus 10 according to a first embodiment of the present invention.

The exposure apparatus 10 is structured in such a manner that various parts are accommodated in a rectangular frame body 12 that is formed by assembling bar-shaped square pipes in the form of a frame. The frame body 12 is shut off between the inside and outside thereof by attaching a panel (not shown) thereto.

The frame body 12 is formed by a long tall housing portion 12A, and a stage portion 12B provided so as to project from one side surface of the housing portion 12A.

The stage portion 12B is provided so that the upper surface thereof is lower that the housing portion 12A. When an operator stands in front of the stage portion 12B, the upper surface of the stage portion 12B is positioned substantially at the height of the operator's waist.

An opening and closing cover 14 is provided on the upper surface of the stage portion 12B. A hinge (not shown) is mounted at one side of the opening and closing cover 14 adjacent to the housing portion 12A, and the opening and closing cover 14 can be operated so as to open and close around the side at which the hinge is mounted.

On the upper surface of the stage portion 12B in a state in which the opening and closing cover 14 is opened, an exposure stage 16 serving as a recording stage can be exposed to the outside.

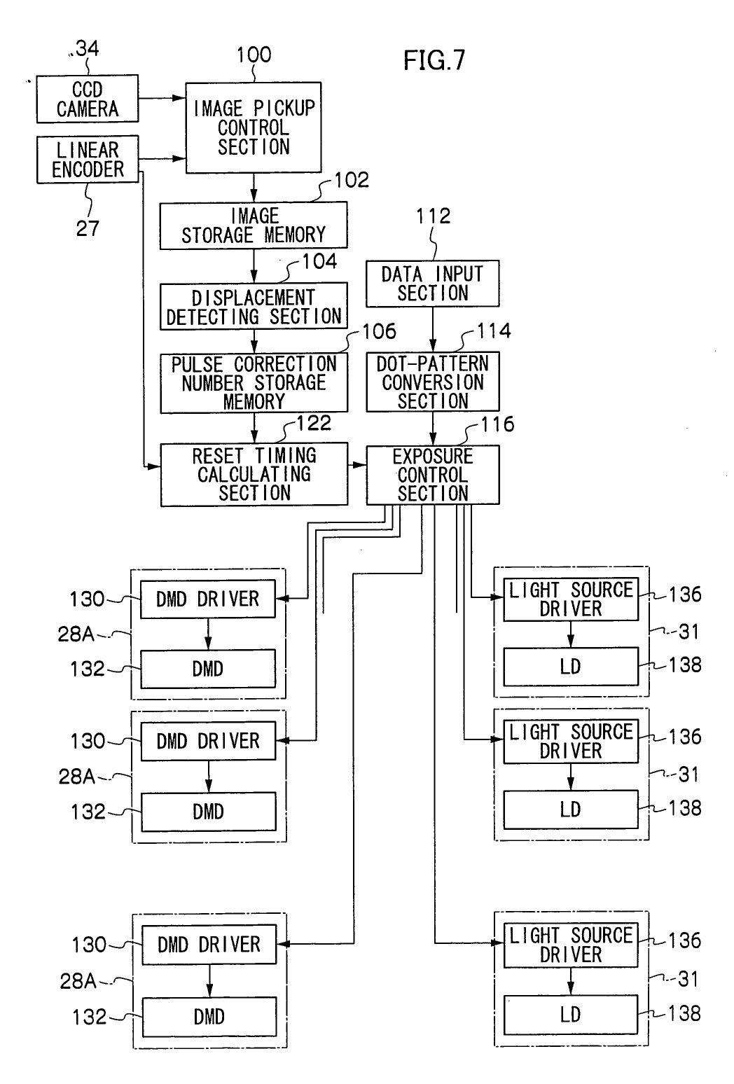

The exposure stage 16 is supported via a pair of sliding rails 20 disposed along the longitudinal direction of a surface plate 18, and is made slidable in the direction indicated by arrow y in FIG. 1A by means of driving force of a linear motor 26 (see FIG. 2) provided below the exposure stage 16. Further, an exposure head unit 28 serving as a recording head is disposed above the exposure stage 16 so as to face the exposure stage 16. Moreover, although not seen in FIG. 1A and FIG. 2, a linear encoder 27 (see FIG. 7) is provided below the exposure stage 16, and a pulse signal is outputted accompanied by movement of the exposure stage 16 and allows detection of positional information and scanning rate of the exposure stage 16 along the sliding rails 20. The linear encoder 27 of the first embodiment is adapted to output a pulse each time the exposure stage 16 moves a predetermined amount (for example, 0.1 μm). Further, in the first embodiment, in order to increase an adjustment resolution, a pulse corresponding to a 0.1 μm-pitch is subject to twice multiplication and a pulse corresponding to a 0.05 μm-pitch is outputted.

The recording medium 22 is positioned on the upper surface of the exposure stage 16, and the exposure stage 16 is provided with a mechanism that absorbs the recording medium 22 and holds the exposure head unit 28 at the height of approximately 200 mm above the exposure surface regardless of the thickness of the recording medium 22. Incidentally, the height adjustment mechanism may be provided at the side of the exposure stage 16, or may be provided at the side of the exposure head unit 28.

Further, markings 24 are provided aside of the recording medium 22 on the upper surface of the exposure stage 16 so as to be arranged at predetermined intervals (in the first embodiment, at intervals of 50 mm) along the directions indicated by double-headed arrow y (since the markings 24 on the exposure stage 16 are fine, they are drawn as a broken line along the directions indicated by double-headed arrow y in FIG. 1A, and FIG. 1B shows an enlarged view of the markings 24).

The exposure head unit 28 is disposed substantially at the intermediate position of the movement route of the exposure stage 16 on the surface plate 18 (in the directions indicated by double-headed arrow y).

The exposure head unit 28 is provided so as to be hung between a pair of supporting posts 30 which are formed upright on the surface plate 18 respectively (at the outer sides of the exposure stage 16) at both transverse-direction ends of the surface plate 18. That is, a gate is thus formed in which the exposure stage 16 passes through a region between the exposure head unit 28 and the surface plate 18.

The exposure head unit 28 is structured in such a manner that a plurality of head assemblies 28A are arranged along the transverse direction of the surface plate 18. By irradiating multiple light beams (described below in detail) emitted from the respective head assemblies 28A at a predetermined timing to the recording medium 22 on the exposure stage 16 while carrying out reciprocating movement of the exposure stage 16, a photosensitive material can be exposed.

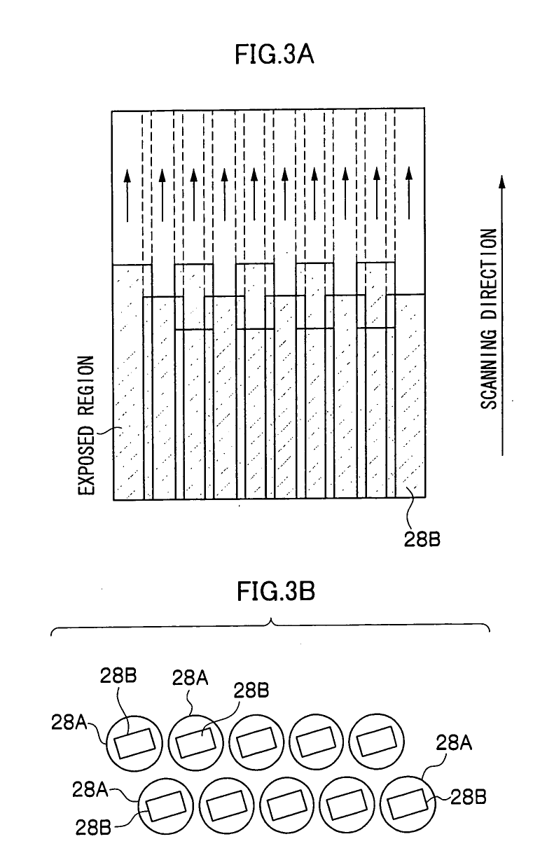

As shown in FIG. 3B, the head assemblies 28A which form the exposure head unit 28 are arranged substantially in the form of a matrix of m rows and n columns (for example, two rows and five columns). These plural head assemblies 28A are arranged in a direction perpendicular to the direction in which the exposure stage 16 is moved (hereinafter referred to as a scanning direction). In the first embodiment, based on the relationship with the transverse dimension of the recording medium 22, ten head assemblies 28A in total are arranged in two rows.

An exposure area 28B of one head assembly 28A is in the shape of a rectangle in which sides along the scanning direction are shorter, and is inclined with respect to the scanning direction by a predetermined angle of inclination. Accompanied by movement of the exposure stage 16, a band-shaped exposed region is formed on the recording medium 22 for each head assembly 28A (see FIG. 3A).

As shown in FIG. 1A, light source units 31 are disposed within the housing portion 12A at positions where movement of the exposure stage 16 on the surface plate 18 is not impeded thereby. The light source units 31 each accommodate multiple lasers (semiconductor lasers), and guide light emitted from the lasers to the respective head assemblies 28A via optical fibers (not shown).

Each of the head assemblies 28A controls, in units of dot, an incident light beam guided by the optical fiber, by means of a digital micro-mirror device (DMD) (not shown) that is a spatial light modulator, and exposes the recording medium 22 to form a dot pattern. In the first embodiment, the density of one pixel is represented using the multiple dot patterns.

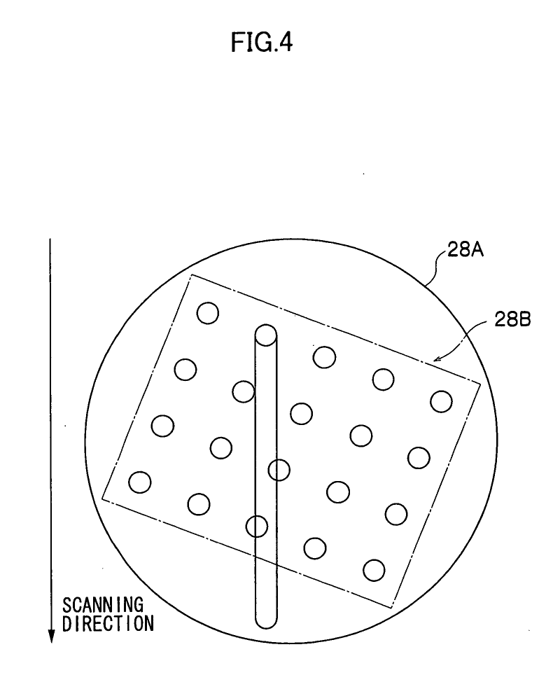

As shown in FIG. 4, the aforementioned band-shaped exposed region (the exposure area 28B in one head assembly 28A) is formed by 20 dots that are disposed in a two-dimensional array (for example, 4×5).

Further, the aforementioned dot pattern in the two-dimensional array is inclined with respect to the scanning direction, and therefore, each of the dots arranged in the scanning direction is adapted to pass through between the dots which are arranged in the direction intersecting the scanning direction. Thus, an effective pitch between dots can be narrowed down, and a high resolution can be achieved.

In the stage portion 12B (see FIG. 1A), exposure processing for the recording medium 22 positioned on the exposure stage 16 is carried out, not when the exposure stage 16 on which the recording medium 22 is placed is moved to the back of the apparatus along the sliding rails 20 on the surface plate 18 (forward movement), but when the exposure stage 16, after having arrived at the end of the surface plate 18 at the back of the apparatus, returns to the stage portion 12B (backward movement).

That is, the forward motion is that for obtaining positional information of the recording medium 22 on the exposure stage 16. As a unit required for obtaining the positional information, an alignment unit 32 (see FIG. 2) is disposed above the surface plate 18.

The alignment unit 32 is disposed at the central portion of the exposure head unit 28 at the back of the apparatus in the forward direction of the exposure stage 16. The alignment unit 32 irradiates light onto the recording medium 22 on the exposure stage 16 during the forward movement, and photographs the reflected light and puts a mark on the recording medium 22.

The relative positional relationship between the exposure stage 16 and the recording medium 22 is determined by an operator's mounting the recording medium 22 on the exposure stage 16, and therefore, minor displacement may occur. The displacement is recognized by the aforementioned photographed mark, and the timing of starting exposure by the exposure head unit 28 having a known relative relationship with the exposure stage 16 is corrected. Thus, the relative position of the recording medium 22 to an image is set as a desired position thereof.

Incidentally, pitching vibration occurs in the exposure stage 16 accompanied by movement thereof, and therefore, displacement occurs on the exposure stage 16. As a result, distortion is caused in an image formed by exposing the recording medium 22 on the exposure stage 16. The pitching vibration mentioned herein occurs depending on manufacturing precision of the exposure stage 16, sliding rails 20, and the like of the exposure apparatus 10, and it is difficult to completely eliminate the pitching vibration from the aspect of the manufacturing precision.

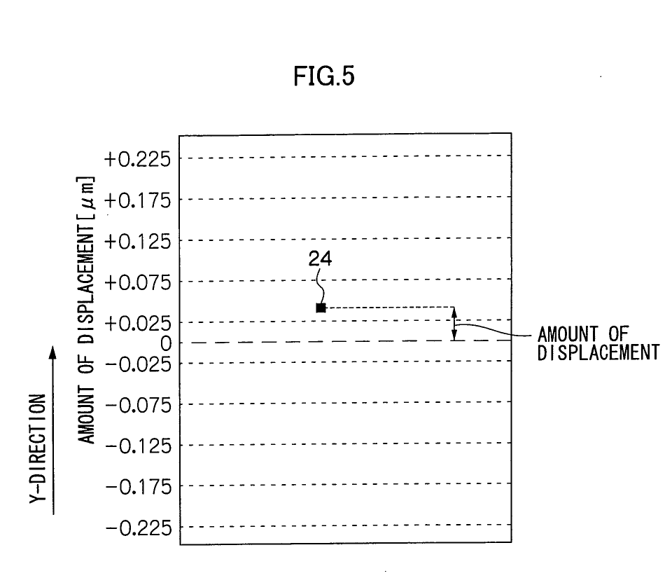

However, the pitching vibration has a high reproducibility based on movement (position) of the exposure stage 16. Therefore, it is possible to correct distortion of an image formed by exposing the recording medium 22 by detecting displacement caused by pitching vibration in advance and effecting correction. Accordingly, one CCD camera 34 is provided as image pick-up means for detecting displacement of the exposure stage 16 caused by pitching vibration that occurs due to movement of the exposure stage 16. The CCD camera 34 is disposed at the front side of the exposure head unit 28 in the forward direction, and can be moved by a built-in linear motor serving as first moving means, to an arbitrary position on a rail 35 provided along the transverse direction of the exposure head unit 28 (i.e., the directions indicated by double-headed arrow x in FIG. 1A), thereby allowing photographing of the markings 24 on the exposure stage 16. A marking image photographed by the CCD camera 34 includes a benchmark used to determine the position of the photographed marking 24 (in the first embodiment, the center in the direction indicated by arrow y is set as the benchmark (0) as shown in FIG. 5), and displacement of a predetermined position of the marking 24 in an image (for example, center of gravity) from the benchmark can be detected.

In other words, in the first embodiment, an amount of correction is stored by previously photographing the marking 24 with the CCD camera 34 and detecting displacement caused by pitching vibration, and based on the stored amount of correction, at the time of exposing the recording medium 22, the exposure timing is corrected. As a result, distortion of an image formed by exposing the recording medium 22 is corrected.

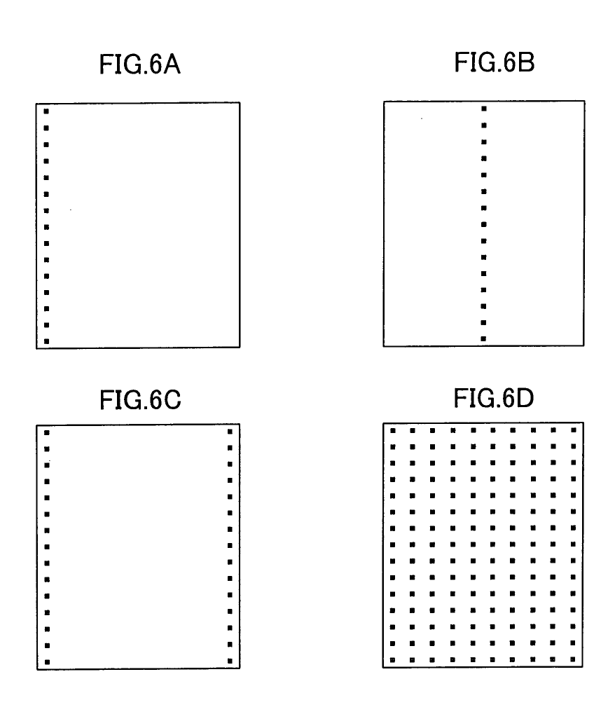

In the first embodiment, one row of markings 24 are provided at one end of the exposure stage 16 as shown in FIG. 6A. However, in a case in which plural rows of markings 24 are provided, for example, the rows of markings 24 are provided respectively at both sides of the exposure stage 16 as shown in FIG. 6B, displacement caused by pitching vibration can be detected at the respective sides by moving the CCD camera 34 along the rail 35. Further, when an image is photographed by the CCD camera 34, displacement may be detected by mounting, on the exposure stage 16, a marking chart (a glass base plate or the like) as shown in FIG. 6C or 6D. In this way, since the CCD camera 34 can be moved along the rail 35, displacement caused by pitching vibration can also be detected for each of the positions of the head assemblies 28A.

FIG. 7 shows a functional block diagram for controlling so as to detect displacement caused by pitching vibration of the exposure stage 16 and carry out exposure in the exposure apparatus 10 of the first embodiment.

An image-pickup control section 100 is connected to the linear encoder 27, the CCD camera 34 and the image storage memory 102. The image-pickup control section 100 makes control for pickup of the marking 24 using the CCD camera 34. The image-pickup control section 100 obtains an image pickup timing by counting 1,000,000 pulses from the linear encoder 27 detected by movement of the exposure stage 16, picks up the marking 24 on the exposure stage 16 using the CCD camera 34 for each obtained image pickup timing, and also stores, in the image storage memory 102, the pickup marking image together with the position of the CCD camera 34 in the direction indicated by arrow x in FIG. 1A. Incidentally, in the linear encoder 27 applied to the first embodiment, each time of movement of the exposure stage 16 with a distance of 0.1 μm, two 2-multiplication pulses are outputted, and the intervals of the markings 24 are each 50 mm. As a result, 50 mm/0.05 μm (=1,000,000) results in that the aforementioned 1,000,000 pulses allows image pickup corresponding to the intervals of markings 24.

The image storage memory 102 is connected to the image-pickup control section 100 and also to a displacement detecting section 104. The image storage memory 102 stores therein a marking image picked up by control of the image-pickup control section 100, and the stored marking image is read out by the displacement detecting section 104.

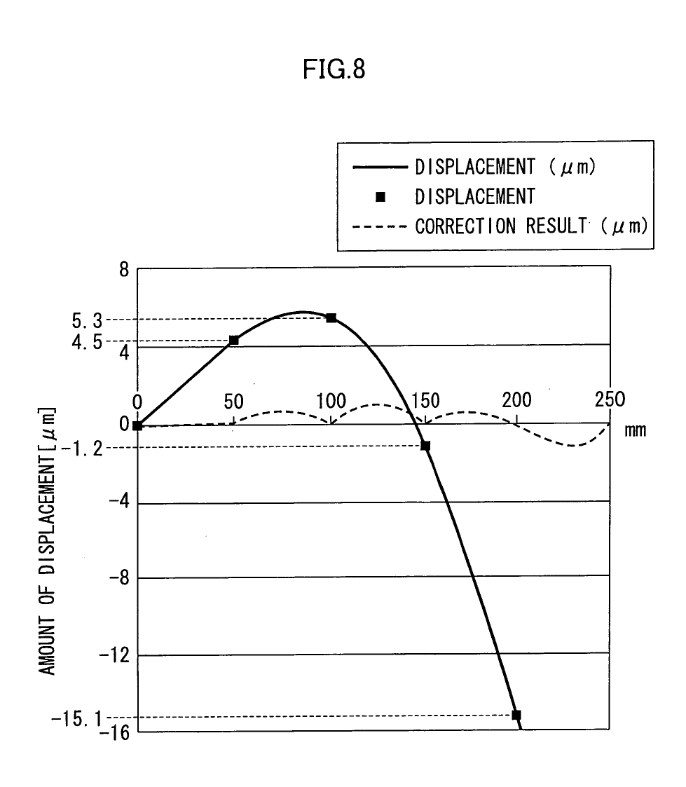

The displacement detecting section 104 is connected to the image storage memory 102 and a pulse correction number storage memory 106. The displacement detecting section 104 detects an amount of displacement of the marking 24 in the marking image picked up by control of the image-pickup control section 100 from a position for the benchmark (0), as is shown in FIG. 5. Further, the displacement detecting section 104 also detects how much the detected amount of displacement has increased or decreased from the amount of displacement detected by the previous image pickup, and calculates a number of 2-multiplication pulses from the linear encoder 27, that is required for correction of displacement occurring between the previous image pickup and the most recent image pickup (in the interval of 50 mm). That is, as shown in FIG. 8, for example, in the case in which an amount of displacement of +4.5 μm is detected when the marking 24 located at a distance of 50 mm is picked up, and an amount of displacement of +5.3 μm is detected when the marking 24 located at a distance of 100 mm is picked up, it is found that an amount of displacement has increased by 0.8 μm (=5.3 μm−4.5 μm) between the previous image pickup and the most recent image pickup (in the interval between the position of 50 mm and the position of 100 mm). Each time the exposure stage 16 moves a distance of 0.05 μm, a 2-multiplication pulse is detected in the linear encoder 27. Therefore, in order to correct the occurred displacement of 0.8 μm, by effecting correction for decreasing 16 pulse numbers (=0.8 μm/0.05 μm), displacement caused in the interval between the position of 50 mm and the position of 100 mm can be corrected. The pulse correction number required for the aforementioned correction is stored in the pulse correction number storage memory 106 together with the position of the CCD camera 34 in the direction indicated by arrow x in FIG. 1A.

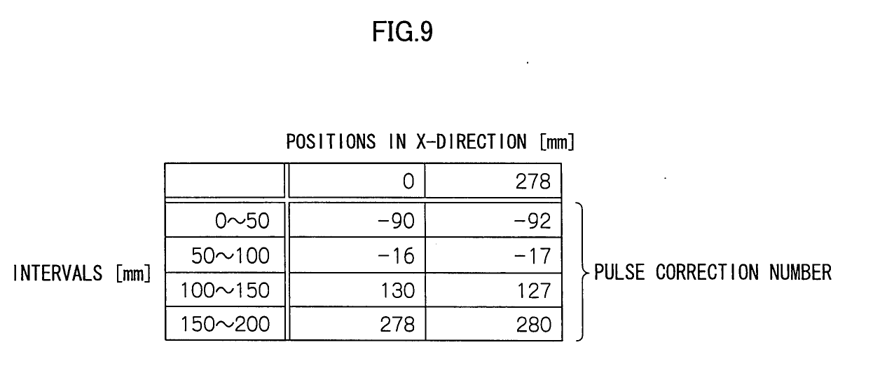

The pulse correction number storage memory 106 is connected to the displacement detecting section 104 and also to a reset-timing calculating section 122. The pulse correction number storage memory 106 stores, as a table shown in FIG. 9, together with the positions in the x-direction of the CCD camera 34 when photographing, pulse correction numbers in respective intervals detected by the displacement detecting section 104 (FIG. 9 shows a case in which the markings 24 are provided respectively at the positions of 0 mm and 278 mm).

The data input section 112 is connected to the dot-pattern conversion section 114. Inputted to the data input section 112 is an image to be exposed on the recording medium 22. The inputted image data is transferred to the dot-pattern conversion section 114.

The dot-pattern conversion section 114 is connected to the data input section 112 and also to an exposure control section 116. The dot-pattern conversion section 114 converts the image data transferred from the data input section 112 to data for each dot (dot-pattern data) for controlling the digital micro-mirror device (DMD) of each head assembly 28A, and also transfers the data to the exposure control section 116.

The exposure control section 116 is connected to the reset-timing calculating section 122, the dot-pattern conversion section 114, the respective head assemblies 28A, and the light source units 31. The exposure control section 116 controls, based on the dot-pattern data transferred from the dot-pattern conversion section 114, the DMD driver 130 of each of the plural head assemblies 28A at each reset timing of the reset-timing calculating section 122 (described later) to set the DMD 132 in an on/off state, and sends a light-up signal to the light source driver 136 of each of the light source units 31 to turn on the LD 138. Thus, image exposure processing on the recording medium 22 is carried out.

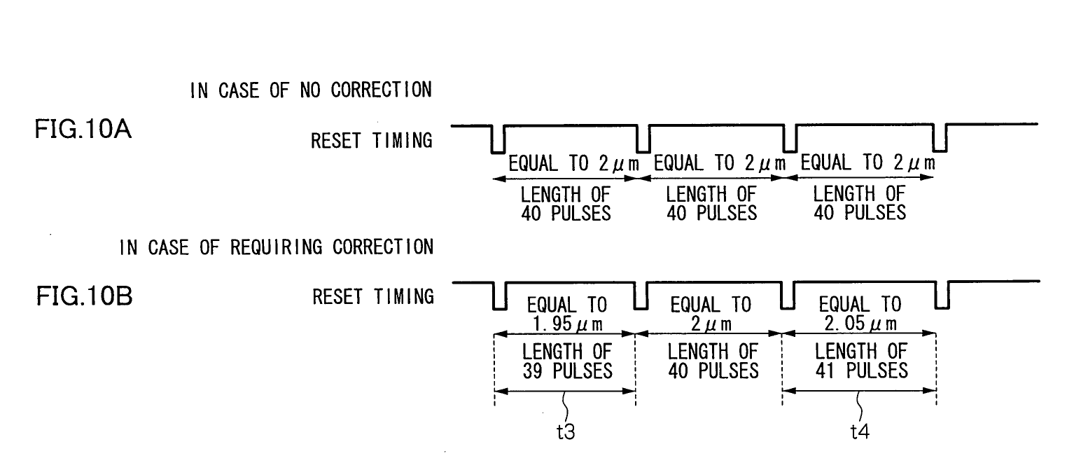

The reset timing calculating section 122 is connected to the linear encoder 27, the pulse correction number storage memory 106, and also to the exposure control section 116. The reset timing calculating section 122 carries out counting 40 pulses from the linear encoder 27 detected by movement of the exposure stage 16 at a time, and thereby sets the reset timing. This reset timing is the timing at which a light beam is irradiated from the head assembly 28A. Further, the reset timing calculating section 122 carries out, based on the table stored in the pulse correction number storage memory 106 and according to position of each head assembly 28A in the x-direction, interpolation processing of pulse correction numbers for the head assemblies 28A, and effects correction for increasing and decreasing the pulse number of 40 pulses, that is the reset timing, for each head assembly 28A. The corrected reset timing is transmitted to the exposure control section 116. That is, the reset timing is, as shown in FIG. 10A, outputted once each time the exposure stage 16 moves a distance of 2.0 μm, therefore, the reset timings are outputted 25,000 times with every interval of the marking 24 (of 50 mm). For example, in the case in which an amount of 16 pulses (0.8 μm) is decreased in the interval between the position of 50 mm and the position of 100 mm, correction can be effected such that 0.05 μm is decreased at each of 16 reset timings among 25,000 reset timings by setting the pulse number of each of the 16 reset timings at 39 pulses (corresponding to the period of time t3 in FIG. 10B). In the case in which the pulse number is increased, correction can be effected such that 0.05 μm is increased at each of 16 reset timings by setting the pulse number at 41 pulses (corresponding to the period of time t4 in FIG. 10B). Incidentally, the intervals of the 16 reset timings in which the pulse number is decreased or increased may be equal among 25,000 reset timings, or may be varied appropriately. Further, only one row of markings 24 is provided on the exposure stage 16, and therefore, in the case in which only data of the one row is stored in the table of the pulse correction number storage memory 106, no interpolation processing is carried out in the reset timing calculating section 122, and correction using data of the one row is carried out for all of the head assemblies 28A.

Next, the operation of the first embodiment will be described.

[Flow of Creation of Pulse Correction Number Data]

In the exposure apparatus 10, creation processing of pulse correction number data is carried out in such a manner that the CCD camera 34 moves along the rail 35 to a position at which the marking 24 of the exposure stage 16 can be picked up thereby, and picks up the marking 24 while moving the exposure stage 16. Incidentally, when plural rows of markings 24 are provided on the exposure stage 16, the creation processing of pulse correction number data is carried out for each row of markings 24 (that is, multiple times), and the pulse correction number is obtained for each of the positions of the markings 24 (the position of the CCD camera 34 in the direction indicated by arrow x) and stored in the pulse correction number storage memory 106.

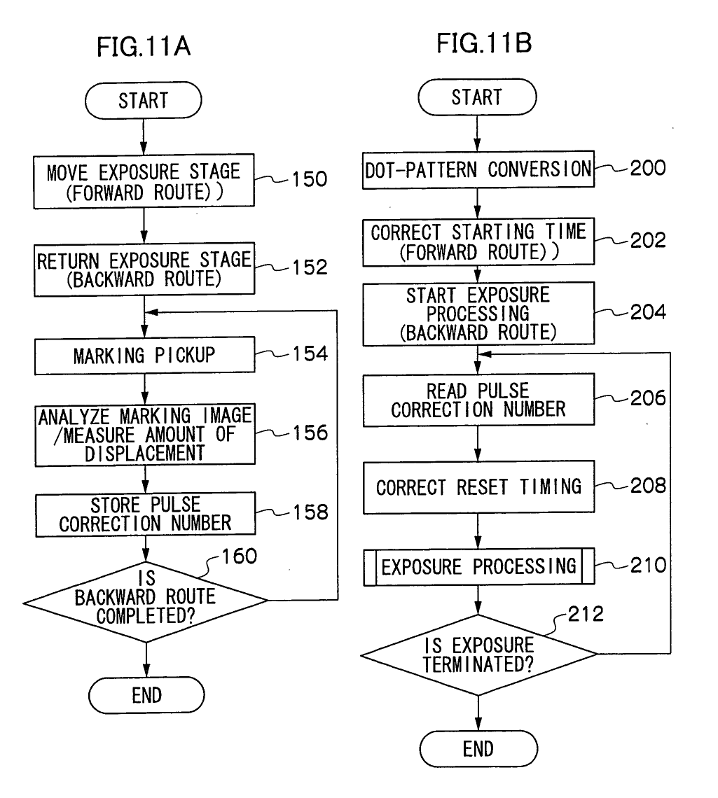

FIG. 11A shows the control flow concerning creation of pulse correction number data.

In step 150, the exposure stage 16 is moved by driving force of the linear motor 26 (see FIG. 2) along the sliding rails 20 of the surface plate 18 at a fixed speed from the stage portion 12B to the back of the housing portion 12A (forward movement), and when the exposure stage 16 arrives at the end of a forward route, the process proceeds to step 152.

In step 152, since the exposure stage 16 arrives at the end of the forward route, the direction in which the exposure stage 16 moves is reversed, and the exposure stage 16 is moved toward the stage portion 12B at a fixed speed (backward movement), and the process proceeds to step 154. In this case, position displacement occurs in the exposure stage 16 due to pitching vibration caused by movement of the exposure stage 16.

In step 154, a pulse from the linear encoder 27, which is generated by movement of the exposure stage 16, is detected, and the pulse number of 1,000,000 are counted up, and an image-pickup timing by the CCD camera 34 is obtained, and further, the markings 24 provided at intervals of 50 mm are picked up. Then, the process proceeds to step 156.

In step 156, an amount of displacement from the position of the marking 24 within a pickup image is obtained, and the process proceeds to step 158.

In step 158, by subtracting the amount of displacement obtained at the previous image-pickup position from the amount of displacement obtained at the current image-pickup position, the amount of displacement in the interval between the previous image-pickup position and the current image-pickup position, and a pulse correction number required for correcting the displacement is obtained and stored in the pulse correction number storage memory 106. Then, the process proceeds to step 160.

In step 160, it is determined whether backward movement of the exposure stage 16 has been completed or not. When the backward movement has been completed, the decision of step 160 is affirmative, and the process ends. On the other hand, when the backward movement has not been completed, the decision of step 160 is negative, the process proceeds to step 154 in which a subsequent marking is picked up.

Due to the creation processing of the pulse correction number data, a table of pulse correction numbers is stored in the pulse correction number storage memory 106.

[Flow of Exposure Processing]

Next, exposure processing in which correction is carried out based on a pulse correction number will be described.

The exposure stage 16 with the recording medium 22 (see FIG. 1A) adhering to the surface thereof is moved by driving force of the linear motor 26 (see FIG. 2) along the sliding rails 20 of the surface plate 18 at a fixed speed from the stage portion 12B to the back of the housing portion 12A (forward movement). In this case, when the exposure stage 16 passes through the alignment unit 32, a mark applied in advance to the recording medium 22 is detected. This mark is collated with a previously stored mark, and based on the positional relationship thereof, the timing of starting exposure of the exposure head unit 28 is corrected.

When the exposure stage 16 arrives at the end of the forward route, the forward movement is reversed and the exposure stage 16 is moved back to the stage portion 12B at a fixed speed (backward movement). During this backward movement, when the exposure stage 16 passes through the exposure head unit 28, exposure processing is started at the corrected timing of starting exposure.

When exposure processing is started in the exposure head unit 28, the reset timing is calculated by the reset timing calculating section 122 (see FIG. 7) from the pulse of the linear encoder 27, which is detected at the time of movement of the exposure stage 16. Based on the calculated reset timing, laser light is irradiated to the DMD. The laser light reflected when the micro-mirror of DMD is in an on state is guided via an optical system to the recording medium 22 (see FIG. 1A), and an image is thereby formed on the recording medium 22.

In this state, when the exposure stage 16 moves, pitching vibration occurs on the exposure stage 16 due to movement thereof, and the recording medium 22 adhering to the surface of the exposure stage 16 also vibrates. As a result, displacement occurs on the recording medium 22 at a position where an image is to be formed by a light beam from the exposure head unit 28. However, the reset timing is corrected according to the position of each head assembly 28A of the exposure head unit 28, and therefore, distortion of an image to be formed by exposure on the recording medium 22 can be reduced.

Next, a description will be given of the control flow of image pickup processing, displacement detecting processing, and exposure processing in accordance with the flow chart of FIG. 11B.

The processing shown in the flow chart of FIG. 11B starts in such a manner that image data is inputted by an operator to the exposure apparatus 10, and process starting control is carried out.

In step 200, the inputted image data is converted to dot-pattern data for exposure by the respective head assemblies 28A of the exposure head unit 28, and the process proceeds to step 202.

In step 202, the timing of starting exposure is corrected by the alignment unit 32 by moving the exposure stage 16 in the forward direction (along the y-axis in FIG. 2, that is, from the front to the back of the apparatus) at a fixed speed. When the exposure stage 16 arrives at the end of the forward route, the process proceeds to step 204.

In step 204, when the exposure stage 16 is moved in the backward direction (along the y-axis in FIG. 2, that is, from the back to the front of the apparatus) at a fixed speed and the timing of starting exposure corrected by step 202 has come, the exposure processing starts and the process proceeds to step 206.

In step 206, the reset timing calculating section 122 (see FIG. 7) detects a pulse from the linear encoder 27, which is generated by movement of the exposure stage 16, obtains the position of the exposure stage 16 in the conveying direction from the pulse number, and reads a pulse correction number of a corresponding interval from the pulse correction number storage memory 106. Then, the process proceeds to step 208.

In step 208, interpolation processing is carried out based on the pulse correction number read by the reset timing calculating section 122, and a pulse correction number corresponding to the position of each head assembly 28A is obtained. Further, in the reset timing calculating section 122, when the reset timing is obtained by counting up a number of pulses generated from the linear encoder 27 up to 40, the reset timing calculating section 122 outputs the reset timing of a pulse number corrected in accordance with the pulse correction number for each head assembly 28A. Then, the process proceeds to step 210.

When no correction is required, the reset timing is set as a timing for every 40 pulses of the linear encoder as shown in FIG. 10A. When correction is required, correction in units of 0.05 μm becomes possible by increasing and decreasing the pulse number as shown in FIG. 10B. If an amount of increase/decrease in displacement in each interval shown in FIG. 8 is in the range of +0.025 μm, correction is not effected. However, if the amount of displacement is larger than +0.025 μm or is smaller than −0.025 μm, correction of the pulse number is effected as required. As a result, the reset timing is corrected so that the amount of displacement in each interval is in the range of ±0.025 μm as shown in the correction result of FIG. 8.

In step 210, the aforementioned exposure processing is carried out based on the reset timing that is corrected, based on the dot-pattern data, and the process proceeds to step 212.

In step 212, it is determined whether exposure processing for all of dot-pattern data has been completed. When the exposure processing for all dot-pattern data has been completed, the decision of step 212 is affirmative, and an image is exposed on the recording medium 22. Therefore, the process ends.

On the other hand, when the exposure processing for all dot-pattern data has not been completed, the decision of step 212 is negative, and the process proceeds to step 206 and then exposure processing is carried out.

As described above, in the first embodiment, an amount of displacement caused by pitching vibration occurring in the exposure stage 16 can be detected at plural positions by making it possible to move one CCD camera 34. Further, by correcting the reset timing for each head assembly 28A based on the detected amount of displacement, distortion of an image to be drawn on the recording medium can be reduced.

Additionally, since amounts of displacement caused by pitching vibration at plural positions can be detected by one CCD camera 34, an increase in the manufacturing cost can be restrained.

Further, since correction is effected by changing a position at which an image is to be drawn, it is not necessary to vary the behavior of the exposure stage 16 due to moving for correction of displacement.

In the first embodiment, the table of pulse correction number is stored in the image storage memory 102. However, an amount of displacement obtained for each interval of the markings 24 (50 mm) may be stored, and at the time of exposure processing, a pulse correction number may be obtained.

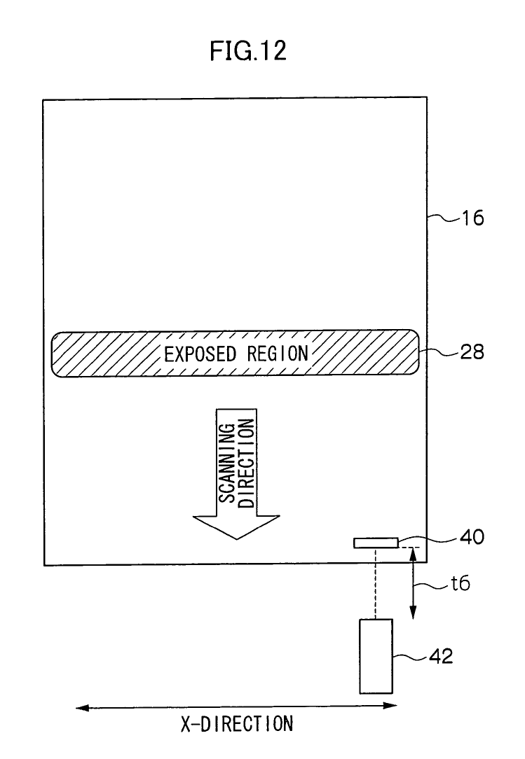

Further, although in the first embodiment, an amount of displacement is detected by picking up the marking 24 on the exposure stage 16, a length measuring portion 40 is provided perpendicular to the exposure stage 16 as shown in FIG. 12, and a distance to the length measuring portion 40 of the exposure stage 16 (a distance t6 in FIG. 12) is measured using a laser length-measuring machine 42 at each image pick-up timing, and based on the intervals by which the distance varies for each image pick-up timing, an amount of displacement caused by pitching vibration of the exposure stage 16 may be detected. In the first embodiment, the amount of displacement can be detected by connecting the laser length-measuring machine 42 to the displacement detecting section 104 (see FIG. 7) and comparing an interval by which a distance to the length-measuring portion 40 of the exposure stage 16 measured at each image pick-up timing in the displacement detecting section 104 varies, with 50 mm (this is because the exposure stage 16 moves at each image pick-up timing by a distance of 50 mm (=1,000,000 pulses×0.05 μm). Further, if plural length-measuring portions 40 are provided on the exposure stage 16, and a rail, motor, and the like which can move the laser length-measuring machine 42 in the directions indicated by double-headed arrow X in FIG. 12 are provided as second moving means, amounts of displacement at plural positions can also be detected. In this way, if the amount of displacement is detected using the laser length-measuring machine 42, the need for providing the markings 24 on the exposure stage 16 is eliminated.

Moreover, although in the first embodiment, image pickup of the markings 24 is carried out in advance and a table for pulse correction numbers is prepared in the image storage memory 102, an amount of displacement caused by pitching vibration may also be detected by carrying out image pickup of the markings 24 in real time (at the same time) at the time of moving the exposure stage 16 for exposure processing. In this case, the displacement detecting section 104 transfers an integer pulse number obtained by dividing the amount of displacement detected from the pickup image by 0.05 μm (2-multiplication pulse) directly to the reset timing calculating section 122, and the reset timing calculating section 122 only needs to effect correction of the reset timing in accordance with the transmitted number of pulse(s), until the image pickup of a subsequent marking 24 is carried out. That is, the reset timing calculating section 122 would constantly effect correction in exposure processing so as to eliminate an amount of displacement detected by image pickup. The real-time correction can also be effected as well even when an amount of displacement is detected using the laser length-measuring machine 42. Due to the real-time correction, a minor difference in the amount of displacement caused by pitching vibration occurring for each exposure processing can also be corrected.

Although in the first embodiment, the reset timing is adjusted by counting up pulses of the linear encoder 27, the reset timing can also be generated by counting up clock signals asynchronously with the linear encoder 27. In this case, if an element or a circuit that outputs a super-high-speed clock signal is used, the reset timing can be adjusted finely by adjusting the count number of clock signals.

### Second Embodiment

Next, a second embodiment of the present invention will be described. The second embodiment is characterized in that, in the exposure apparatus 10, a pattern image for acquiring position data is formed, an amount of displacement caused by pitching vibration is detected by measuring (the length of) the exposed pattern image, and register a table concerning pulse correction numbers in the pulse correction number storage memory 106.

An exposure apparatus 10 of the second embodiment is not provided with the CCD camera 34 and the rail 35. Other parts of the exposure apparatus 10 are the same as those of FIGS. 1 and 2, and therefore, a description thereof will be omitted.

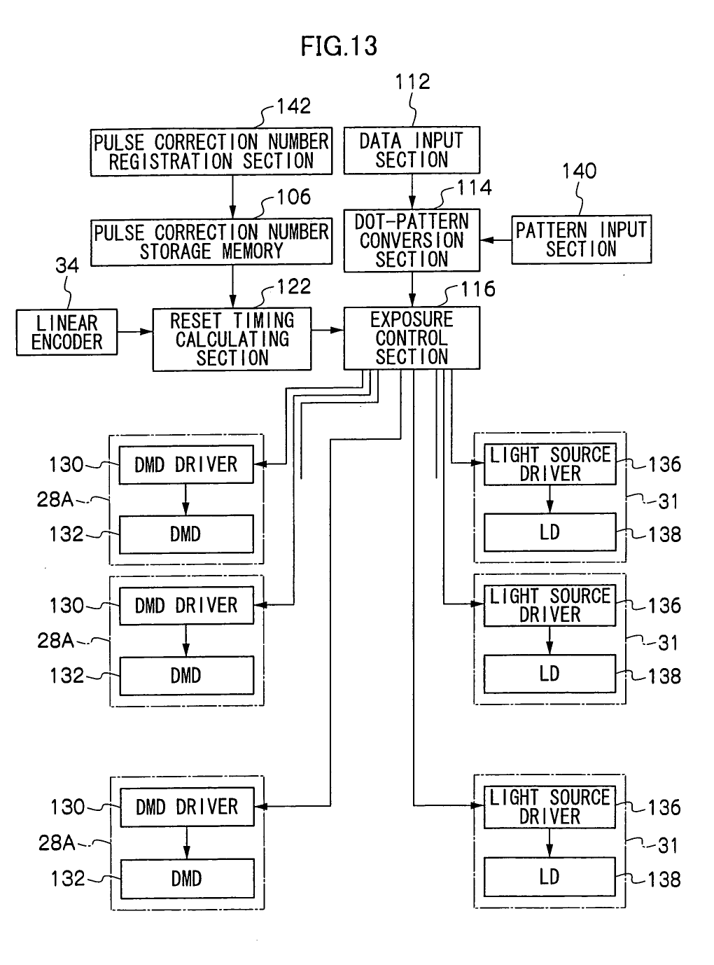

FIG. 13 shows a functional diagram of the second embodiment. Note that the same parts as those of FIG. 7 in the first embodiment will be denoted by the same reference numerals, and therefore, a description thereof will be omitted and only different parts will be described below.

A pattern input section 140 is connected to a dot-pattern conversion section 114. When the pattern input section 140 receives an instruction for exposure of a pattern image for acquiring position data to detect an amount of displacement caused by pitching vibration, it delivers plural rows of markings 24, as the pattern image, to the dot-pattern conversion section 114 as shown in FIG. 6D. In this case, the intervals between the markings 24 in row direction in the pattern image are each set to be, for example, 50 mm. Due to delivery of the pattern image, image exposure processing on the recording medium 22 is carried out in the exposure apparatus 10. However, pitching vibration occurs due to movement of the exposure stage 16, and therefore, displacement occurs in an image that is to be actually exposed. In the second embodiment, the intervals between the markings 24 in the row direction in the pattern image exposed on the recording medium 22 are measured by an operator or the like, and each compared with 50 mm, thereby obtaining an amount of displacement. Thus, a pulse correction number in each interval in each of the rows of the markings 24 is obtained.

A pulse correction number registration section 142 is connected to a pulse correction number storage memory 106. The pulse correction number registration section 142 carries out registration of the obtained pulse correction number, and can store the pulse correction number in the pulse correction number storage memory 106. As a result, a table of pulse correction numbers is stored in the pulse correction number storage memory 106.

In the exposure apparatus 10 of the second embodiment, displacement caused by pitching vibration is corrected in such a manner that the same exposure processing as that of the first embodiment is carried out by the pulse correction number registered by the pulse correction number registration section 142. For this reason, it is not necessary to provide a CCD camera or the like so as to detect pitching vibration.

Next, the operation of the second embodiment will be described.

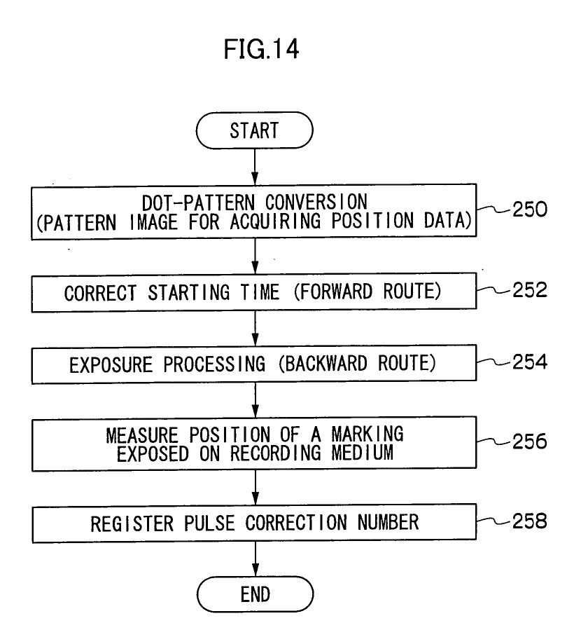

FIG. 14 shows the flow concerning exposure of a pattern image for acquiring position data, and acquisition of a pulse correction number.

In step 250, if an instruction for exposure of a pattern image for acquiring position data is given, the pattern image shown in FIG. 6D is converted to dot-pattern data, and the process proceeds to step 252.

In step 252, the exposure stage 16 is moved at a fixed speed in the forward direction (along the y-axis in FIG. 2 and from the front to the back of the apparatus), and the timing of starting exposure is corrected by the alignment unit 32. When the exposure stage 16 arrives at the end of the forward route, the process proceeds to step 254.

In step 254, when the exposure stage 16 is moved at a fixed speed in the backward direction (along the y-axis in FIG. 2 and from the back to the front of the apparatus) and the corrected timing of starting exposure has come, exposure processing of dot-pattern data is started and a pattern image is exposed on the recording medium 22. Then, the process proceeds to step 256.

In step 256, an amount of displacement from each marking 24 in each of the rows of exposed pattern image is measured, and the pulse correction number in each interval is obtained. Then, the process proceeds to step 258.

In step 258, registration of the pulse correction number for each interval of the markings 24 in each of the rows is carried out, and the pulse correction number is stored in the pulse correction number storage memory 106. Thereafter, the process ends.

Since the pulse correction storage memory 106 stores therein a table of pulse correction numbers, exposure processing allows correction of displacement caused by pitching vibration.

In this manner, the second embodiment makes it possible to detect an amount of displacement caused by pitching vibration by exposing the marking 24 as a pattern image for acquiring position data. Further, it is possible to detect an amount of displacement for each row of markings by providing plural rows of the markings 24 and also detect an amount of displacement at an arbitrary position on the exposure stage 16 by changing the positions of the rows of the markings 24 to be exposed (the positions in the direction indicated by arrow X).

As described above, in the present embodiment, displacement of a recording stage, which is caused by pitching vibration of the recording state, is detected at plural positions, and a timing at which a light beam is irradiated is corrected for each of positions of recording heads in accordance with the detected displacement-amount data. Accordingly, the present invention has an excellent effect in that displacement caused by pitching vibration occurring due to movement of the recording stage can be corrected and distortion of an image to be drawn on the recording medium can be reduced.

1. An exposure apparatus in which a light beam from a recording head is irradiated on a recording medium mounted on a recording stage, and the recording stage and the recording head are relatively moved, thereby allowing a predetermined image to be exposed on the recording medium, said apparatus comprising:
a displacement detecting section that detects displacement caused by pitching vibration occurring accompanied by movement of the recording stage;
a storage section that stores therein displacement-amount data detected by said displacement detecting section;
a correction section that corrects, based on the displacement-amount data stored in said storage section, a timing at which the light beam is irradiated from the recording head; and
a control section that controls, based on the timing corrected by said correction section, exposure for the recording medium.

2. An exposure apparatus in which light beams from plural recording heads arranged linearly are irradiated on a recording medium mounted on a recording stage, and the recording stage is relatively moved in a direction intersecting a direction in which the recording heads are arranged linearly, thereby allowing a predetermined image to be exposed on the recording medium, said apparatus comprising:
a displacement detecting section that detects displacement caused by pitching vibration that occurs accompanied by movement of the recording stage;
a storage section that stores therein displacement-amount data detected by said displacement detecting section;
a correction section that corrects, based on the displacement-amount data stored in said storage section, a timing at which the light beam is irradiated for each of the recording heads; and
a control section that controls, based on the timing corrected by said correction section, exposure for the recording medium.

3. The exposure apparatus according to claim 1, wherein one row of markings are provided on the recording stage so as to be arranged at fixed intervals along a direction in which the recording stage and the recording head are relatively moved, and wherein said displacement detecting section comprises:
at least one image pickup section that picks up the markings on the one row on the recording stage at each predetermined timing;
a first moving section that moves said image pickup section in a direction intersecting the direction of relative movement, thereby allowing the markings on the one row to be picked up; and
a first detecting section that detects, based on the position of the marking within an image picked up by said image pickup section, the displacement caused by pitching vibration of the recording stage.

4. The exposure apparatus according to claim 2, wherein one row of markings are provided on the recording stage so as to be arranged at fixed intervals along a direction in which the recording stage and the recording heads are relatively moved, and wherein said displacement detecting section comprises:
at least one image pickup section that picks up the markings on the one row on the recording stage at each predetermined timing;
a first moving section that moves said image pickup section in a direction intersecting the direction of relative movement, thereby allowing the markings on the one row to be picked up; and
a first detecting section that detects, based on the position of the marking within an image picked up by said image pickup section, the displacement caused by pitching vibration of the recording stage.

5. The exposure apparatus according to claim 1, wherein plural rows of markings are provided on the recording stage so as to be arranged at fixed intervals along a direction in which the recording stage and the recording head are relatively moved, and wherein said displacement detecting section comprises:
at least one image pickup section that picks up the markings on each of the plural rows on the recording stage at each predetermined timing;
a first moving section that moves said image pickup section in a direction intersecting the direction of relative movement, thereby allowing the markings on each of the plural rows to be picked up; and
a first detecting section that detects, based on the position of the marking within an image picked up by said image pickup section, the displacement caused by pitching vibration of the recording stage.

6. The exposure apparatus according to claim 2, wherein plural rows of markings are provided on the recording stage so as to be arranged at fixed intervals along a direction in which the recording stage and the recording heads are relatively moved, and wherein said displacement detecting section comprises:
at least one image pickup section that picks up the markings on each of the plural rows on the recording stage at each predetermined timing;
a first moving section that moves said image pickup section in a direction intersecting the direction of relative movement, thereby allowing the markings on each of the plural rows to be picked up; and
a first detecting section that detects, based on the position of the marking within an image picked up by said image pickup section, the displacement caused by pitching vibration of the recording stage.

7. The exposure apparatus according to claim 1, wherein said displacement detecting section comprises:
a laser length-measuring machine that is disposed in a direction in which the exposure head moves relatively to the recording stage, and measures a distance to the recording stage at each predetermined timing;
a second moving section that moves said laser length-measuring machine in a direction intersecting the direction of the relative movement within a range in which the distance to the recording stage can be measured; and
a second detecting section that detects the displacement caused by pitching vibration of the recording stage, based on a changed amount of the distance to the recording stage, measured by said laser length-measuring machine at each predetermined timing.

8. The exposure apparatus according to claim 2, wherein said displacement detecting section comprises:
a laser length-measuring machine that is disposed in a direction in which the exposure head moves relatively to the recording stage, and measures a distance to the recording stage at each predetermined timing;
a second moving section that moves said laser length-measuring machine in a direction intersecting the direction of the relative movement within a range in which the distance to the recording stage can be measured; and
a second detecting section that detects the displacement caused by pitching vibration of the recording stage, based on a changed amount of the distance to the recording stage, measured by said laser length-measuring machine at each predetermined timing.

9. The exposure apparatus according to claim 1, wherein said displacement detecting section comprises:
a position pattern exposure section that forms a predetermined position-data-acquiring pattern on the recording medium by exposing the recording medium; and
a registration section that registers, in said storage section, the displacement-amount data obtained from the position-data-acquiring pattern formed on the recording medium by exposing by said position pattern exposure section.

10. The exposure apparatus according to claim 2, wherein said displacement detecting section comprises:
a position pattern exposure section that forms a predetermined position-data-acquiring pattern on the recording medium by exposing the recording medium; and
a registration section that registers, in said storage section, the displacement-amount data obtained from the position-data-acquiring pattern formed on the recording medium by exposing by said position pattern exposure section.

11. The exposure apparatus according to claim 3, wherein the markings are provided on the recording stage by mounting a marking chart on which the markings are formed on the recording stage.

12. The exposure apparatus according to claim 5, wherein the markings are provided on the recording stage by mounting a marking chart on which the markings are formed on the recording stage.

13. The exposure apparatus according to claim 2, wherein said displacement detecting section detects the displacement at each of positions corresponding to all the recording heads.

14. The exposure apparatus according to claim 6, wherein said displacement detecting section detects the displacement at each of positions corresponding to all the recording heads, based on the positions of the markings on each of the plural rows picked up by said image pickup section.

15. The exposure apparatus according to claim 7, wherein said laser length-measuring machine is provided so as to measure a distance to a length measuring portion provided on the recording stage at each predetermined timing.

16. The exposure apparatus according to claim 8, wherein said laser length-measuring machine is provided so as to measure a distance to a length measuring portion provided on the recording stage at each predetermined timing.

17. The exposure apparatus according to claim 9, wherein said position pattern exposure section includes a pattern input section for inputting the position-data-acquiring pattern.

18. The exposure apparatus according to claim 10, wherein said position pattern exposure section includes a pattern input section for inputting the position-data-acquiring pattern.

19. An exposure method in which a light beam from a recording head is irradiated on a recording medium mounted on a recording stage, and the recording stage and the recording head are relatively moved, thereby allowing a predetermined image to be exposed on the recording medium, said method comprising the steps of:
detecting an amount of displacement caused by pitching vibration occurring accompanied by movement of the recording stage;
storing data of the amount of displacement;
correcting, based on the data of the stored amount of displacement, a timing at which the light beam is irradiated from the recording head; and
controlling exposure for the recording medium based on the corrected timing.

20. An exposure method in which light beams from plural recording heads arranged linearly are irradiated on a recording medium mounted on a recording stage, and the recording stage is relatively moved in a direction intersecting a direction in which the recording heads are arranged linearly, thereby allowing a predetermined image to be exposed on the recording medium, said method comprising the steps of:
detecting displacement caused by pitching vibration that occurs accompanied by movement of the recording stage;
storing data of the detected amount of displacement;
correcting, based on the data of the stored displacement-amount data, a timing at which the light beam is irradiated for each of the recording heads; and
controlling exposure for the recording medium based on the corrected timing.
